(19) United States
(12) Patent Application Publication
(10) Pub. No.: US 2003/0118735 A1
(43) Pub. Date: Jun. 26, 2003

(54) Hybrid organic-inorganic composite film and method for the manufacture thereof

(76) Inventors: Anand Mahadeo Gole, Maharashtra (IN); Ashavani Kumar, Maharashtra (IN); Sumant Phadtare, Maharashtra (IN); Murali Sastry, Maharashtra (IN)

Correspondence Address: Norman H. Stepno. Esquire, BURNS, DOANE, SWECKER & MATHIS, L.L.P., P.O. Box 1404, Alexandria, VA, 22313-1404, US

(21) Appl. No.: 10/024,172

(22) Filed: Dec. 21, 2001

(51) Int. Cl. B05D 3/02

(52) U.S. Cl. 427/384

(57) ABSTRACT

A hybrid organic-inorganic composite film useful for glucose sensing in aqueous solutions is disclosed along with methods for manufacture thereof and a method of glucose sensing using such novel film.

### FIELD OF THE INVENTION

The present invention relates to a hybrid organic-inorganic composite film. More particularly, the present invention relates to a hybrid organic-inorganic composite film useful for glucose sensing in aqueous solutions. The invention also relates to a method for the manufacture of a hybrid organic-inorganic composite film useful for glucose sensing in aqueous solutions by observing colour change in the film and a method of glucose sensing using such novel film.

### BACKGROUND OF THE INVENTION

Conventional methods for the detection of glucose use amperometric techniques involving the use of expensive enzymes such as glucose oxidase or horse radish peroxidase. Other synthetic techniques for the detection of glucose require boronic acid derivatives that often involve time consuming and costly synthetic protocols.

Prior art discloses processes for the detection of glucose in small and large amounts [Hiratsuka, A., et al, (1999) Electroanalysis, 11, 1098]. Eggert, H., et al disclose the use of boronic acid derivatives for detection of glucose [(1999) J. Org. Chem., 64, 3846]. In another method, an electrode is formed on an insulating base plate with a reaction layer in contact or in the vicinity of the plate. The reaction layer contains an enzyme glucose dehydrogenase for glucose sensing along with coenzyme pyrrolo-quinoline quinone. The reaction layer also contains an additive such as phthalic acid [Yugawa, K., et al, (2000), EP 992589].

An apparatus for measuring saliva glucose is available which works on the principle of detection of electrolytic current generated by the reaction of glucose present in saliva and an enzyme present in the sensor strip [Toyama, T., (2000), Jpn Kokai Tokkyo Koho JP 2000074914]. A single or double layered membrane with immobilized glucose oxidase and glucose isomerase is covered on the responsive surface of an electrode for measurement of glucose in biological samples. For example, glucose oxidase and glucose isomerase were mixed with solution collagen and the mixture was spread on a glass plate to form a single layer type sensor [Kendo, F., (1981), Jpn Kokai Tokkyo Koho JP 56092441].

The major drawbacks of the earlier methods for detection of glucose are:

1. Expensive chemicals such as enzymes are used

2. Electrochemical techniques are used which rely on current changes and require a lot of equipment maintenance.

3. The processes are highly complex and time consuming

Accordingly, there is a need to develop glucose sensors, which overcome the drawbacks associated with the prior art techniques enumerated above.

### OBJECTS OF THE INVENTION

The main object of the present invention is to provide a hybrid organic-inorganic composite film useful in the sensing of glucose in aqueous solutions.

It is another object of the present invention to provide a method for the manufacture of a hybrid organic-inorganic composite film useful in the sensing of glucose in aqueous solution.

It is a further object of the invention to provide a technique for glucose sensing in aqueous solutions which is faster, less complex, economical, bio-friendly and efficient.

### SUMMARY OF THE INVENTION

The present invention is based on the reduction of gold ions in cationic or anionic form incorporated in lipid film on suitable substrates such as glass, by glucose in solution to form striking purple coloured colloidal gold in film in order to sense the presence of glucose in solution by colorimetric methods.

Accordingly the present invention provides a hybrid organic-inorganic composite film comprising gold ions diffused in a lipid film deposited on a substrate.

In one embodiment of the invention, the gold ions are selected from cationic and anionic forms of gold ions.

In a further embodiment of the invention, the cationic form of gold ion comprises auric chloride and the anionic form of the gold ion comprises chloroaurate obtained from chloroauric acid.

In another embodiment of the invention, the substrate is selected from the group consisting of glass, quartz and transparent polymer.

In a further embodiment of the invention, the transparent polymer is selected from plastic, Perspex or fiber material.

In another embodiment of the invention, the lipid comprising the film layer is selected from the group consisting of fatty acids, fatty amines, fatty alcohols and phospholipids with a hydrocarbon chain lengths of 12 to 22 carbon atoms.

In a further embodiment of the invention, the fatty amine comprises octadecylamine.

In a further embodiment of the invention, the fatty acid comprises arachidic acid.

In a further embodiment of the invention, the fatty alcohol comprises octadecanol.

In a further embodiment of the invention, the phospholipid comprises 1-phosphatidylethanolamine.

In another embodiment of the invention, the thickness of the lipid film is in the range of 250 Å-1000 Å, preferably about 500 Å.

The invention also relates to a method for the manufacture of a hybrid organic-inorganic composite film comprising depositing a lipid film on a substrate and immersing the lipid film deposited substrate in an aqueous solution of gold salt to obtain a hybrid organic-inorganic composite film with gold ion diff-used in lipid film.

In one embodiment of the process of the invention, the concentration of the gold solution is in the range of 10⁻⁵ to 1 M.

In one embodiment of the invention, the gold ions are selected from cationic and anionic forms of gold ions.

In another embodiment of the invention, the gold salt is selected from the group consisting of chloroaurate and auric chloride.

In another embodiment of the invention, the lipid film is formed by a method selected from the group consisting of thermal evaporation, spin coating, drop coating and Langmuir-Blodgett method.

In another embodiment of the invention, the substrate is selected from the group consisting of glass, quartz and transparent polymer.

In a further embodiment of the invention, the transparent polymer is selected from plastic, Perspex or fiber material.

In another embodiment of the invention, the lipid comprising the film layer is selected from the group consisting of fatty acids, fatty amines, fatty alcohols and phospholipids with a hydrocarbon chain lengths of 12 to 22 carbon atoms.

In a further embodiment of the invention, the fatty amine comprises octadecylamine.

In a further embodiment of the invention, the fatty acid comprises arachidic acid.

In a further embodiment of the invention, the fatty alcohol comprises octadecanol.

In a further embodiment of the invention, the phospholipid comprises 1-phosphatidylethanolamine.

In another embodiment of the invention, the thickness of the lipid film is in the range of 250 Å-1000 Å, preferably about 500 Å.

The invention also relates to the use of a hybrid organic-inorganic composite film comprising of gold ions diffused in a lipid film deposited on a substrate for glucose sensing.

In one embodiment of the invention, the hybrid organic-inorganic composite film comprising of gold ions diffused in a lipid film deposited on a substrate is immersed in an aqueous solution, the presence of glucose being indicated by colour change in the film.

In one embodiment of the invention, the gold ions are selected from cationic and anionic forms of gold ions.

In another embodiment of the invention, the gold salt is selected from the group consisting of chloroaurate and auric chloride.

In another embodiment of the invention, the substrate is selected from the group consisting of glass, quartz and transparent polymer.

In a further embodiment of the invention, the transparent polymer is selected from plastic, Perspex or fiber material.

In another embodiment of the invention, the lipid comprising the film layer is selected from the group consisting of fatty acids, fatty amines, fatty alcohols and phospholipids with a hydrocarbon chain lengths of 12 to 22 carbon atoms.

In a further embodiment of the invention, the fatty amine comprises octadecylamine.

In a further embodiment of the invention, the fatty acid comprises arachidic acid.

In a further embodiment of the invention, the fatty alcohol comprises octadecanol.

In a further embodiment of the invention, the phospholipid comprises 1-phosphatidylethanolamine.

In another embodiment of the invention, the thickness of the lipid film is in the range of 250 Å-1000 Å, preferably about 500 Å.

### DETAILED DESCRIPTION OF THE INVENTION

In the process of the invention, a lipid film is deposited on a suitable substrate such as glass by conventional methods of film formation such as thermal evaporation. This is then immersed in a solution of one or more gold salts. Electrostatic interactions are to a large extent responsible for the diffusion of gold ions in the lipid film resulting in the formation of organic-inorganic hybrid composite film.

This film on further immersion in aqueous solutions of glucose changes colour between red to purple depending on the concentration of glucose, indicating the reduction of chloroaurate ions by glucose. The change in colour of the film is due to the reduction of chloroaurate ions in the film by glucose resulting in the formation of gold colloidal particles in the film which shows striking red/purple colours.

Without wishing to be bound by any theory, it is believed that the colours of red and purple are due to the collective excitations of electrons known as plasma oscillations or interband transmissions and are a characteristic property of metal colloids. The method of glucose sensing using the film of the invention is more economical, faster and easier to use due to a less complicated protocol.

The invention will now be described in greater detail with reference to the following illustrative and non-binding examples.

Preparation of Hybrid Organic-Inorganic Composite Film

### EXAMPLE 1

A 100 Å thick fatty amine film of octadecylamine (ODA) was deposited on glass by thermal evaporation. This film was then immersed in 20 ml of 10⁻⁴ M concentrated aqueous solution of chloroauric acid for a period of 6 hours. Electrostatic interactions are mainly responsible for the intercaltaion of gold anions into the cationic lipid film. The organic-inorganic film formed was rinsed and dried and analysed using infrared spectroscopy.

### EXAMPLE 2

A fatty acid film of arachidic acid was spin coated on quartz. This film was then immersed in 20 ml of 10⁻¹ M auric chloride solution for a period of 2 hours. Electrostatic interactions between the positively charged gold cations and the negatively charged anionic lipid matrix drives the ions into the film leading to the formation of organic-inorganic hybrid film. The film was analysed using infrared spectroscopy.

### EXAMPLE 3

250-1000 Å thick neutral fatty alcohol (octadecanol) film was formed onto a transparent plastic substrate. This film was immersed in cationic gold solution to form the hybrid film. The intercalation of gold ions into the matrix is driven by secondary interactions. The film was analysed using infrared spectroscopy.

### EXAMPLE 4

A 250-1000 Å thick neutral fatty alcohol (octadecanol) film was formed onto a transparent plastic substrate. This film was immersed in anionic gold solution to form the hybrid film. The intercalation of gold ions into the matrix is driven by secondary interactions. The film was analysed using infrared spectroscopy.

### EXAMPLE 5

A 500 Å thick film of 1-phosphatidylethanolamine (DOPE) was formed by thermal evaporation. This film was immersed in 10⁻³ chloroauric acid solution for a period of 6 hours. The diffusion of chloroaurate ions into the phospholipid was driven by electrostatic interactions. The hybrid formation was confirmed byinfrared spectroscopy.

Use of Hybrid Organic-Inorganic Film to Detect Glucose

### EXAMPLE 6

The fatty amine-chloroauric acid hybrid film was immersed in 0.1 M concentrated glucose solution held at room temperature for a period of 6 hours. A reddish blue colour developed in the film indicating the reduction of chloroaurate ions in the hybrid film by glucose molecules. The glucose in turn oxidizes to form gluconic acid. The colloidal gold particles formed in the film were characterised by UV-vis spectroscopy.

### EXAMPLE 7

This example illustrates the detection of glucose in aqueous solutions within short time period. A 1000 Å thick octadecylamine-chloroaurate hybrid film was immersed in 0.1 M glucose solution held at 60° C. for a period of 1 hour. A reddish colour developed in the film, which was monitored spectrophotometrically.

### EXAMPLE 8

This example illustrates the detection of low concentration of glucose in solution. A 1000 Å thick arachidic acid-auric chloride hybrid film was immersed in 10⁻³ M glucose solution held at pH in the range of 9-12. A red colour developed in the film within a period of 1 hour. The colour change was recorded by UV-vis spectroscopy.

### EXAMPLE 9

This example illustrates the rapid detection of very low concentration of glucose in solution. A 1000 Å thick ODA-chloroaurate ion hybrid film was immersed in 10⁻³ M aqueous solution of glucose held at pH in the range of 9-12 and at 60° C. A reddish blue colour developed in the film within a period of 15 minutes, thus enhancing the time scales of detection.

We claim

1. A hybrid organic-inorganic composite film comprising gold ions diffused in a lipid film deposited on a substrate.

2. A hybrid organic-inorganic composite film as claimed in claim 1 wherein the gold ions are selected from cationic and anionic forms of gold.

3. A hybrid organic-inorganic composite film as claimed in claim 2 wherein the cationic form of gold ion comprises auric chloride.

4. A hybrid organic-inorganic composite film as claimed in claim 2 wherein the anionic form of the gold ion comprises chloroaurate obtained from chloroauric acid.

5. A hybrid organic-inorganic composite film as claimed in claim 1 wherein the substrate is selected from the group consisting of glass, quartz and transparent polymer.

6. A hybrid organic-inorganic composite film as claimed in claim 5 wherein the transparent polymer is selected from plastic, Perspex or fiber material.

7. A hybrid organic-inorganic composite film as claimed in claim 1 wherein the lipid comprising the film layer is selected from the group consisting of fatty acids, fatty amines, fatty alcohols and phospholipids with a hydrocarbon chain length of 12 to 22 carbon atoms.

8. A hybrid organic-inorganic composite film as claimed in claim 7 wherein the fatty amine comprises octadecylamine.

9. A hybrid organic-inorganic composite film as claimed in claim 7 wherein the fatty acid comprises arachidic acid.

10. A hybrid organic-inorganic composite film as claimed in claim 7 wherein the fatty alcohol comprises octadecanol.

11. A hybrid organic-inorganic composite film as claimed in claim 7 wherein the phospholipid comprises 1-phosphatidylethanolamine.

12. A hybrid organic-inorganic composite film as claimed in claim 1 wherein the thickness of the lipid film is in the range of 250 Å-1000 Å.

13. A hybrid organic-inorganic composite film as claimed in claim 12 wherein the thickness of the lipid film is about 500 Å.

14. A method for the manufacture of a hybrid organic-inorganic composite film comprising depositing a lipid film on a substrate and immersing the lipid film deposited substrate in an aqueous solution of gold salt to obtain a hybrid organic-inorganic composite film with gold ion diffused in lipid film.

15. A method as claimed in claim 14 wherein the concentration of the gold solution is in the range of 10⁻⁵ to 1 M.

16. A method as claimed in claim 14 wherein the gold ions are selected from cationic and anionic forms of gold.

17. A method as claimed in claim 14 wherein the gold salt is selected from the group consisting of chloroaurate and auric chloride.

18. A method as claimed in claim 14 wherein the lipid film is formed by a method selected from the group consisting of thermal evaporation, spin coating, drop coating and Langmuir-Blodgett method.

19. A method as claimed in claim 14 wherein the substrate is selected from the group consisting of glass, quartz and transparent polymer.

20. A method as claimed in claim 19 wherein the transparent polymer is selected from plastic, Perspex or fiber material.

21. A method as claimed in claim 14 wherein the lipid comprising the film layer is selected from the group consisting of fatty acids, fatty amines, fatty alcohols and phospholipids with a hydrocarbon chain length of 12 to 22 carbon atoms.

22. A method as claimed in claim 21 wherein the fatty amine comprises octadecylamine.

23. A method as claimed in claim 21 wherein the fatty acid comprises arachidic acid.

24. A method as claimed in claim 21 wherein the fatty alcohol comprises octadecanol.

25. A method as claimed in claim 21 wherein the phospholipid comprises 1-phosphatidylethanolamine.

26. A method as claimed in claim 14 wherein the thickness of the lipid film is in the range of 250 Å-1000 Å.

27. A method as claimed in claim 26 wherein the thickness of the lipid film is about 500 Å.

28. A method for glucose sensing comprising using a hybrid organic-inorganic composite film comprising of gold ions diffused in a lipid film deposited on a substrate.

29. A method as claimed in claim 28 wherein said film is immersed in an aqueous solution, the presence of glucose being indicated by colour change in the film.

30. A method as claimed in claim 28 wherein the gold ions are selected from cationic and anionic forms of gold.

31. A method as claimed in claim 28 wherein the gold salt is selected from the group consisting of chloroaurate and auric chloride.

32. A method as claimed in claim 28 wherein the substrate is selected from the group consisting of glass, quartz and transparent polymer.

33. A method as claimed in claim 32 wherein the transparent polymer is selected from plastic, Perspex or fiber material.

34. A method as claimed in claim 28 wherein the lipid comprising the film layer is selected from the group consisting of fatty acids, fatty amines, fatty alcohols and phospholipids with a hydrocarbon chain length of 12 to 22 carbon atoms.

35. A method as claimed in claim 34 wherein the fatty amine comprises octadecylamine.

36. A method as claimed in claim 34 wherein the fatty acid comprises arachidic acid.

37. A method as claimed in claim 34 wherein the fatty alcohol comprises octadecanol.

38. A method as claimed in claim 34 wherein the phospholipid comprises 1-phosphatidylethanolamine.

39. A method as claimed in claim 28 wherein the thickness of the lipid film is in the range of 250 Å-1000 Å.

40. A method as claimed in claim 39 wherein the thickness of the lipid film is about 500 Å.
